(19) United States
(12) Patent Application Publication
(10) Pub. No.: US 2026/0126549 A1
(43) Pub. Date: May 7, 2026

(54) DISTANCE MEASUREMENT METHOD AND SYSTEM FOR LIDAR

(71) Applicant: BEIJING MORELITE TECHNOLOGY CO. LTD., Beijing (CN)

(72) Inventors: Pingjie XIA, Beijing (CN); Chunlin YANG, Beijing (CN); Jie SUN, Beijing (CN); Tianbo SUN, Beijing (CN)

(21) Appl. No.: 19/378,646

(22) Filed: Nov. 4, 2025

(30) Foreign Application Priority Data
Nov. 6, 2024 (CN) 202411571739.8

(51) Int. Cl. G01S 17/58; G01S 7/4915

(52) U.S. Cl. CPC G01S 17/58; G01S 7/4915

(57) ABSTRACT

A distance measurement method and system for LIDAR are provided, which includes: generating a frequency-swept light beam; splitting the frequency-swept light beam into a signal light beam and a local-oscillator light beam, where each of the signal light beam and the local-oscillator light beam includes first and second frequency-up phases, first and second frequency-down phases, slope of the first frequency-up phase is different from that of the second frequency-up phase, slope of the first frequency-down phase is different from that of the second frequency-down phase; emitting a signal light beam; receiving a reflected light beam; detecting beat frequencies of the frequency-up phases and the frequency-down phases between the local-oscillator light beam and the reflected light beam; and using two of beat frequencies of the frequency-up phases and frequency-down phases to measure the speed of the target object and/or the distance between the target object and the LIDAR.

### CROSS-REFERENCE TO RELATED APPLICATION

The present application claims a priority to Chinese Patent Application No. 202411571739.8 filed on Nov. 6, 2024, the disclosures of which are incorporated in their entirety by reference herein.

### TECHNICAL FIELD

The present application relates to the technical field of LIDAR, and specifically to a distance measurement method and system for LIDAR.

### BACKGROUND

Light Detection And Ranging (LIDAR) can accurately measure the position (distance and angle), motion state (speed, vibration, and attitude) and shape of a target object, as well as detect, identify, distinguish, and track the target object. Lidar can be divided into pulse LIDAR and frequency-modulated continuous-wave (FMCW) LIDAR according to its working mode. A typical FMCW LIDAR emits a laser beam and uses a detector to receive the reflected beam of the target object from the surrounding environment, thereby calculating information such as the distance and speed of the target object. However, the reflected beam used to calculate distance and speed includes an optical Doppler frequency shift introduced by the movement of the target object. When the speed of the target object is relatively high, the frequency shift caused by the Doppler effect is greater than the frequency shift caused by the flight time of the reflected beam. This leads to errors in the calculation of short-distance information and thus results in a measurement blind area.

### SUMMARY

In view of the problems of the related LIDAR, the present application provides a distance measurement method and system for LIDAR.

In a first aspect, the distance measurement method for LIDAR includes: generating a frequency-swept light beam; splitting the frequency-swept light beam into a signal light beam and a local-oscillator light beam, where each of the signal light beam and the local-oscillator light beam includes a first frequency-up phase, a second frequency-up phase, a first frequency-down phase, and a second frequency-down phase, the slope of the first frequency-up phase is different from that of the second frequency-up phase, and the slope of the first frequency-down phase is different from that of the second frequency-down phase; emitting the signal light beam; receiving the reflected light beam generated by the reflection of the signal light beam when it encounters a target object; detecting the beat frequencies of the first frequency-up phase, the second frequency-up phase, the first frequency-down phase, and the second frequency-down phase between the local-oscillator light beam and the reflected light beam; and using two of the beat frequencies of the first frequency-up phase, the second frequency-up phase, the first frequency-down phase, and the second frequency-down phase to measure the speed of the target object and/or the distance between the target object and the LIDAR.

Optionally, using two of the beat frequencies of the first frequency-up phase, the second frequency-up phase, the first frequency-down phase, and the second frequency-down phase to measure the speed of the target object and/or the distance between the target object and the LIDAR includes: using the beat frequencies of the first frequency-up phase and the second frequency-up phase to measure the speed of the target object and/or the distance between the target object and the LIDAR; or using the beat frequencies of the first frequency-down phase and the second frequency-down phase to measure the speed of the target object and/or the distance between the target object and the LIDAR.

Optionally, using the beat frequencies of the first frequency-up phase and the second frequency-up phase to measure the distance between the target object and the LIDAR includes: obtaining the distance D between the target object and the LIDAR using the following formula:

D=k₀×(f_{bu2}−f_{bu1})/(k_{f}−1), where k₀ is a preset value related to the LIDAR, k_{f} is a parameter related to the ratio of the slope of the first frequency-up phase to the slope of the second frequency-up phase, f_{bu1} is the beat frequency of the first frequency-up phase, and f_{bu2} is the beat frequency of the second frequency-up phase.

Optionally,

$${k}_{0} = \frac{T \times c}{4 \times {f}_{B 1}} , {k}_{f} = \frac{{f}_{B 2}}{{f}_{B 1}}$$

where f_{B1} is the frequency-sweeping bandwidth of the linear frequency modulation of the first triangular wave, f_{B2} is the frequency-sweeping bandwidth of the linear frequency modulation of the second triangular wave, T is the period of the frequency-up and frequency-down sweeps, and c is the speed of light in a vacuum.

Optionally, using the beat frequencies of the first frequency-down phase and the second frequency-down phase to measure the distance between the target object and the LIDAR includes: obtaining the distance D between the target object and the LIDAR using the following formula:

D=k₀×(f_{bd2}−f_{bd1})/(k_{f}−1), where k₀ is a preset value related to the LIDAR, k_{f} is a parameter related to the ratio of the slope of the first frequency-down phase to the slope of the second frequency-down phase, f_{bd1} is the beat frequency of the first frequency-down phase, and f_{bd2} is the beat frequency of the second frequency-down phase.

Optionally, using the beat frequencies of the first frequency-up phase and the second frequency-up phase to measure the speed of the target object includes: obtaining the speed V of the target object using the following formula:

V=k₁×(k_{f}×f_{bu1}−f_{bu2})/(k_{f}−1), where k₁ is a preset value related to the LIDAR, k_{f} is a parameter related to the ratio of the slope of the first frequency-up phase to the slope of the second frequency-up phase, f_{bu1} is the beat frequency of the first frequency-up phase, and f_{bu2} is the beat frequency of the second frequency-up phase.

Optionally, using the beat frequencies of the first frequency-down phase and the second frequency-down phase to measure the speed of the target object includes:
obtaining the speed V of the target object using the following formula:

V=k₁×(k_{f}×f_{bd1}−f_{bd2})/(k_{f}−1), where k₁ is a preset value related to the LIDAR, k_{f} is a parameter related to the ratio of the slope of the first frequency-down phase to the slope of the second frequency-down phase, f_{bd1} is the beat frequency of the first frequency-down phase, and f_{bd2} is the beat frequency of the second frequency-down phase.

Optionally,

$${k}_{1} = λ / 2 , {k}_{f} = \frac{{f}_{B 2}}{{f}_{B 1}} ,$$

where f_{B1} is the frequency-sweeping bandwidth of the linear frequency modulation of the first triangular wave, f_{B2} is the frequency-sweeping bandwidth of the linear frequency modulation of the second triangular wave, and λ is the wavelength of the local-oscillator light beam.

In a second aspect, the present application provides a distance measurement system for LIDAR. The distance measurement system includes: a laser source configured to generate a frequency-swept light beam; a beam splitter configured to split the frequency-swept light beam into a signal light beam and a local-oscillator light beam, where each of the signal light beam and the local-oscillator light beam includes a first frequency-up phase, a second frequency-up phase, a first frequency-down phase, and a second frequency-down phase, the slope of the first frequency-up phase is different from that of the second frequency-up phase, and the slope of the first frequency-down phase is different from that of the second frequency-down phase; an optical transceiver configured to emit the signal light beam and receive the reflected light beam generated by the reflection of the signal light beam when it encounters a target object; a frequency mixer configured to perform optical frequency mixing between the local-oscillator light beam and the reflected light beam; a balanced detector configured to obtain the beat frequency electrical signal between the local-oscillator light beam and the reflected light beam; a detector configured to obtain the beat frequency electrical signal from the balanced detector, and detect the beat frequencies of the first frequency-up phase, the second frequency-up phase, the first frequency-down phase, and the second frequency-down phase between the local-oscillator light beam and the reflected light beam according to the beat frequency electrical signal; and a measuring device configured to use the beat frequencies of the first frequency-up phase and the second frequency-up phase to measure the speed of the target object and/or the distance between the target object and the LIDAR; or use the beat frequencies of the first frequency-down phase and the second frequency-down phase to measure the speed of the target object and/or the distance between the target object and the LIDAR.

Optionally, the measuring device is specifically configured to: obtain the distance D between the target object and the LIDAR using the following formula: D=k₀×(f_{bu2}−f_{bd1})/(k_{f}−1), where k₀ is a preset value related to the LIDAR, k_{f} is a parameter related to the ratio of the slope of the first frequency-up phase to the slope of the second frequency-up phase, f_{bu1} is the beat frequency of the first frequency-up phase, and f_{bu2} is the beat frequency of the second frequency-up phase.

Optionally, the measuring device is specifically configured to: obtain the distance D between the target object and the LIDAR using the following formula: D=k₀×(f_{bd2}−f_{bd1})/(k_{f}−1), where k₀ is a preset value related to the LIDAR, k_{f} is a parameter related to the ratio of the slope of the first frequency-down phase to the slope of the second frequency-down phase, f_{bd1} is the beat frequency of the first frequency-down phase, and f_{bd2} is the beat frequency of the second frequency-down phase.

Optionally, the measuring device is specifically configured to: obtain the speed V of the target object using the following formula: V=k₁×(k_{f}×f_{bu1}−f_{bu2})/(k_{f}−1), where k₁ is a preset value related to the LIDAR, k_{f} is a parameter related to the ratio of the slope of the first frequency-up phase to the slope of the second frequency-up phase, f_{bu1} is the beat frequency of the first frequency-up phase, and f_{bu2} is the beat frequency of the second frequency-up phase.

Optionally, the measuring device is specifically configured to: obtain the speed V of the target object using the following formula: V=k₁×(k_{f}×f_{bd1}−f_{bd2})/(k_{f}−1), where k₁ is a preset value related to the LIDAR, k_{f} is a parameter related to the ratio of the slope of the first frequency-down phase to the slope of the second frequency-down phase, f_{bd1} is the beat frequency of the first frequency-down phase, and f_{bd2} is the beat frequency of the second frequency-down phase.

In a third aspect, the present application provides a distance measurement system for LIDAR. The measurement system includes:
a signal source transmitting module, a beat frequency signal acquisition module, and a measurement module. The signal source transmitting module is used to transmit a periodic frequency-modulated continuous wave to a target object, where the time-frequency waveform of the frequency-modulated continuous wave in one frequency-sweeping period includes a first frequency-up phase, a second frequency-up phase, a first frequency-down phase, and a second frequency-down phase, the slope of the first frequency-up phase is different from that of the second frequency-up phase, and the slope of the first frequency-down phase is different from that of the second frequency-down phase. The beat frequency signal acquisition module is used to respectively obtain the beat frequency f_{bd1} of the first frequency-down phase, the beat frequency f_{bd2} of the second frequency-down phase, the beat frequency f_{bu1} of the first frequency-up phase, and the beat frequency f_{bu2} of the second frequency-up phase based on the reflected signal returned by the target object. The measurement module is configured to use the beat frequency f_{bu1} of the first frequency-up phase and the beat frequency f_{bu2} of the second frequency-up phase to measure the speed v of the target object and/or the distance D between the target object and the LIDAR; or use the beat frequency f_{bd1} of the first frequency-down phase and the beat frequency f_{bd2} of the second frequency-down phase to measure the speed v of the target object and/or the distance D between the target object and the LIDAR.

Optionally, the measurement module is specifically configured to: obtain the distance D between the target object and the LIDAR using the following formula: D=k₀×(f_{bu2}−f_{bu1})/(k_{f}−1), where k₀ is a preset value related to the LIDAR, and k_{f} is a parameter related to the ratio of the slope of the first frequency-up phase to the slope of the second frequency-up phase.

Optionally, the measurement module is specifically configured to: obtain the speed V of the target object using the following formula: V=k₁×(k_{f}×f_{bu1}−f_{bu2})/(k_{f}−1), where k₁ is a preset value related to the LIDAR, and k_{f} is a parameter related to the ratio of the slope of the first frequency-up phase to the slope of the second frequency-up phase.

In a fourth aspect, the present application provides an autonomous vehicle, which includes the LIDAR according to the second aspect or the third aspect.

### BRIEF DESCRIPTION OF THE DRAWINGS

FIG. 1 is a schematic structural diagram of the continuous-wave LIDAR of the present application;

FIG. 2A shows a schematic diagram of measuring a stationary target object using a related triangular wave linear frequency-modulated continuous-wave LIDAR;

FIG. 2B shows a schematic diagram of measuring a target object moving towards the LIDAR using a related triangular wave linear frequency-modulated continuous-wave LIDAR;

FIG. 2C shows a schematic diagram of measuring a target object moving away from the LIDAR using a related triangular wave linear frequency-modulated continuous-wave LIDAR;

FIG. 3 shows a schematic diagram of a measurement blind area caused by the Doppler effect when measuring with a related LIDAR;

FIGS. 4A-4D are schematic diagrams of different waveforms of triangular waves provided in some embodiments of the present application;

FIG. 5 shows a schematic diagram of measuring a target object moving towards the LIDAR using the LIDAR distance measurement method provided in the present application;

FIG. 6 shows a schematic diagram of measuring a target object moving away from the LIDAR using the LIDAR distance measurement method provided in the present application;

FIG. 7 shows a flowchart of the LIDAR distance measurement method provided in the present application;

FIG. 8 shows a schematic structural diagram of the LIDAR distance measurement system provided in the present application;

FIG. 9 shows another schematic structural diagram of the LIDAR distance measurement system provided in the present application; and

FIGS. 10A and 10B illustrate an example autonomous vehicle according to an embodiment of the present application.

### DETAILED DESCRIPTION

In order to make the objectives, technical solutions, and advantages of the present application clearer, the following will further describe the present application in detail with reference to the accompanying drawings. Obviously, the described embodiments are only a part of the embodiments of the present application, rather than all the embodiments. Based on the embodiments in the present application, all other embodiments obtained by those of ordinary skill in the art without making creative work shall fall within the protection scope of the present application.

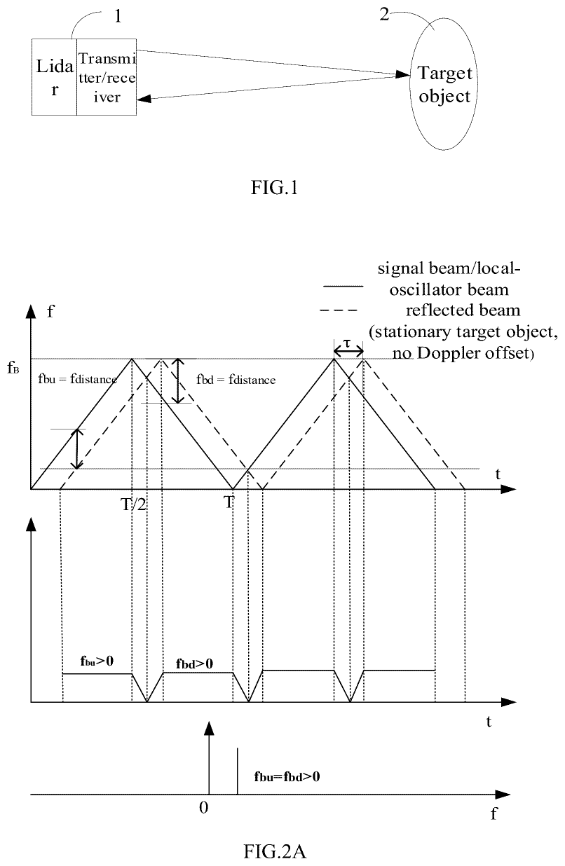

Referring to FIG. 1, FIG. 1 is a schematic structural diagram of the continuous-wave LIDAR of the present application. The continuous-wave LIDAR 1 of the present application adopts the working principle of coherent reception.

By comparing the instantaneous frequency relationship between the reflected beam reflected from the target object 2 and the local-oscillator beam of the LIDAR 1, information such as the distance between the target object 2 and the LIDAR 1 and the speed of the target object can be given simultaneously.

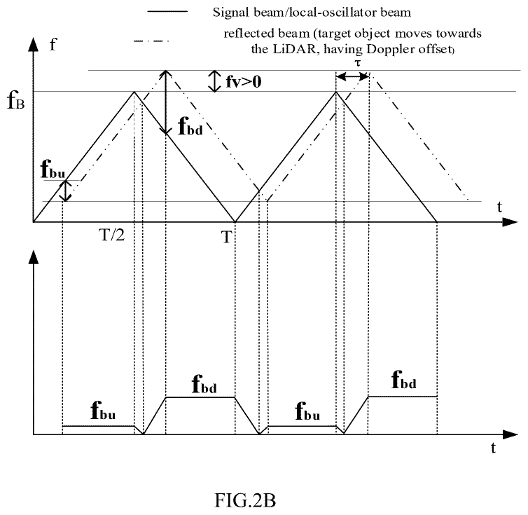

The existing frequency-modulated continuous-wave (FMCW) LIDAR emits a continuous laser beam, and the frequency of the laser beam is modulated to change periodically. As shown in FIG. 2A, the time-domain waveform of the frequency change is a periodic symmetric triangular wave.

The frequency change process of the emitted beam corresponding to the rising edge of the triangular wave is called the “frequency-up sweep” or frequency-up phase, and the frequency change process corresponding to the falling edge of the triangular wave is called the “frequency-down sweep” or frequency-down phase. The triangular wave FMCW LIDAR mixes the received reflected beam (called the “echo beam”) reflected and/or scattered from the target object with the local reference beam (called the “local-oscillator beam”) to obtain the beat frequency signal (called the intermediate frequency signal fir) between the local-oscillator beam and the echo beam. Then, through a spectrum analysis algorithm (based on discrete Fourier transform (FFT) and its deformation, expansion, and other algorithms), the frequencies of the beat frequency signals (also called the “frequency-up sweep segment intermediate frequency signal” and “frequency-down sweep segment intermediate frequency signal”) corresponding to the rising edge and falling edge periods of the triangular wave are analyzed to obtain the distance between the target object and the LIDAR and the radial speed of the target object relative to the LIDAR.

Referring to FIG. 2A, FIG. 2A shows a schematic diagram of measuring a stationary target object using a related triangular wave FMCW LIDAR. In FIG. 2A, the solid triangular wave represents the instantaneous time-frequency relationship of the signal beam or local-oscillator beam of the radar, and the dashed triangular wave represents the reflected beam of the stationary target object. Among them, τ is the delay of the reflected beam of the stationary target object, which is caused by the round-trip flight of the laser beam between the target object and the LIDAR. f_{bu} and f_{bd} are the beat frequencies of the reflected beam of the stationary target object in the frequency-up sweep part and the frequency-down sweep part respectively, T is the period of the frequency-up sweep and frequency-down sweep, and f_{B} is the frequency-sweeping bandwidth of the linear frequency modulation. In FIG. 2A, the beat frequencies of the reflected beam in the frequency-up phase and the frequency-down phase are respectively:

$${f}_{bu} = \frac{2 {f}_{B}}{T} \cdot \frac{2 D}{c} = {f}_{distance} \qquad Formula 1$$

$${f}_{bd} = \frac{2 {f}_{B}}{T} \cdot \frac{2 D}{c} = {f}_{distance}$$

Assuming that the distance between the target object and the LIDAR is D, then D=τ*c/2, where c is the speed of light and λ is the laser wavelength;

then, in the time-frequency relationship diagram of FIG. 2A, the relationship between the beat frequencies f_{bu} (in the frequency-up phase) and f_{bd} (in the frequency-down phase) of the reflected beam and the distance D of the target object is as follows:

$$D = \frac{( {f}_{bu} + {f}_{bd} ) \cdot T \cdot c}{8 {f}_{B}} \qquad Formula 2$$

FIG. 2B shows a schematic diagram of measuring a target object moving towards the LIDAR using a related triangular wave linear frequency-modulated continuous-wave LIDAR. In FIG. 2B, the solid triangular wave represents the instantaneous s time-frequency relationship of the signal beam or local-oscillator beam of the radar, and the dashed triangular wave represents the reflected beam of the target object moving towards the LIDAR. Among them, τ is the delay of the reflected beam of the target object, f_{bu} and f_{bd} are the beat frequencies of the reflected beam of the target object in the frequency-up sweep part and the frequency-down sweep part respectively, T is the period of the frequency-up sweep and frequency-down sweep, f_{B} is the frequency-sweeping bandwidth of the linear frequency modulation, and fᵥ=(f_{bd}−f_{bu})/2. fv is the Doppler frequency shift of the echo signal caused by the radial movement of the target object relative to the LIDAR. When the radial relative movement speed of the target object is towards the LIDAR, the value of fv is positive, that is, greater than 0.

In FIG. 2B, the beat frequencies of the reflected beam in the frequency-up phase and the frequency-down phase are respectively:

$${f}_{bu} = \frac{2 {f}_{B}}{T} \cdot \frac{2 D}{c} - \frac{2 v}{λ} = {f}_{distance} - {f}_{v} \qquad Formula 3$$

$${f}_{bd} = \frac{2 {f}_{B}}{T} \cdot \frac{2 D}{c} + \frac{2 v}{λ} = {f}_{distance} + {f}_{v}$$

The distance D and speed ν of the target object are as follows:

$$\{ \begin{matrix}D = \frac{( {f}_{bu} + {f}_{bd} ) \cdot T \cdot c}{8 {f}_{B}} \\ v = \frac{( {f}_{bu} - {f}_{bd} ) \cdot λ}{4}\end{matrix} \qquad Formula 4$$

FIG. 2C shows a schematic diagram of measuring a target object moving away from the LIDAR using a related triangular wave linear frequency-modulated continuous-wave LIDAR. In FIG. 2C, the solid triangular wave represents the instantaneous time-frequency relationship of the signal beam or local-oscillator beam of the radar, and the dashed triangular wave represents the reflected beam of the target object moving away from the LIDAR. Among them, τ is the delay of the reflected beam of the target object, f_{bu} and f_{bd} are the beat frequencies of the reflected beam of the target object in the frequency-up sweep part and the frequency-down sweep part respectively, T is the period of the frequency-up sweep and frequency-down sweep, f_{B} is the frequency-sweeping bandwidth of the linear frequency modulation, and fᵥ=(f_{bd}−f_{bu})/2. fᵥ is the Doppler frequency shift of the echo signal caused by the radial movement of the target object relative to the LIDAR. When the radial relative movement speed of the target object is away from the LIDAR, the value of fᵥ is negative (that is, less than 0).

In FIG. 2C, the beat frequencies of the reflected beam in the frequency-up phase and the frequency-down phase are respectively:

$${f}_{bu} = \frac{2 {f}_{B}}{T} \cdot \frac{2 D}{c} + \frac{2 v}{λ} = {f}_{distance} - {f}_{v} \qquad Formula 5$$

$${f}_{bd} = \frac{2 {f}_{B}}{T} \cdot \frac{2 D}{c} - \frac{2 v}{λ} = {f}_{distance} + {f}_{v}$$

The distance D and speed ν of the target object are as follows:

$$\{ \begin{matrix}D = \frac{( {f}_{bu} + {f}_{bd} ) \cdot T \cdot c}{8 {f}_{B}} \\ v = \frac{( {f}_{bu} - {f}_{bd} ) \cdot λ}{4}\end{matrix} \qquad Formula 6$$

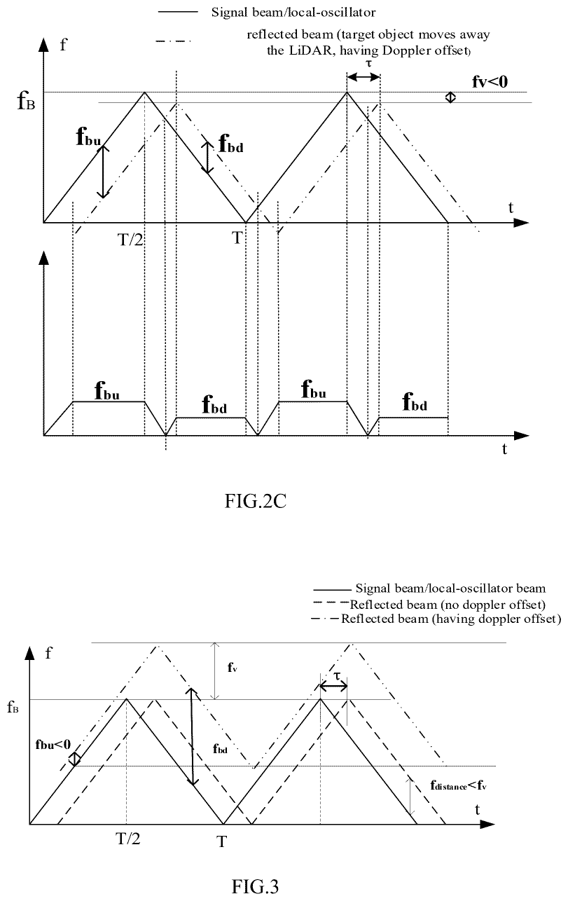

The above Formulas 3 to 6 all assume that f_{bu} and f_{bd} are greater than 0, to obtain the calculated distance D between the target object and the LIDAR and the speed ν of the target object, the absolute values (i.e., positive values) of f_{bu} and f_{bd} above need to be used. However, when the actual speed ν of the target object is relatively high, the frequency shift caused by the Doppler effect may be greater than the frequency shift caused by the flight time of the reflected beam, resulting in the actual value of the beat frequency f_{bu} in the frequency-up phase between the received local-oscillator beam and the reflected beam being negative, as shown in FIG. 3. Although the actual beat frequency f_{bu} in the frequency-up phase between the received local-oscillator beam and the reflected beam is negative (less than 0), the LIDAR judges the frequency f_{bu} as positive (greater than 0). Therefore, when the above formulas are used to calculate the distance and speed of the target object, errors will occur in the calculation of the distance and speed, leading to a measurement blind area. In addition, when the rotating mirror device of the LIDAR rotates at a high speed, a large Doppler frequency shift will also be generated. The Doppler frequency shift introduced by the rotation of the rotating mirror and the Doppler frequency shift of the target object are superimposed on each other, which may also cause the frequency shift caused by the Doppler effect to exceed the frequency shift caused by the flight time of the reflected beam, resulting in errors in the calculation of the distance and speed of the target object and causing a measurement blind area. In addition, when f_{bu} and/or f_{bd} are small enough, the actual circuit design and calculation limitations will cause the distance measurement system of the LIDAR to fail to detect the f_{bu} or f_{bd}, thus making it impossible to accurately calculate the distance D and speed v of the target object.

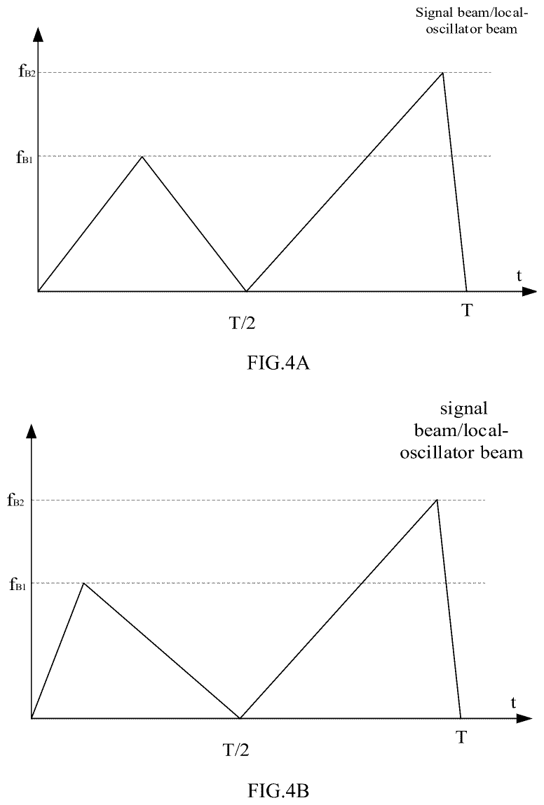

In view of the above problems, the present application provides a laser distance measurement method for FMCW LIDAR. The laser distance measurement method adopts two triangular wave waveforms with different shapes in the same frequency-sweeping period. As shown in FIGS. 4A-4D, different from the traditional triangular wave FMCW LIDAR, the frequency-modulated continuous wave includes two triangular waves in one frequency-sweeping period T. The shapes of these two triangular waves are different. The slope of the frequency-up phase of the first triangular wave is different from the slope of the frequency-up phase of the second triangular wave, and the slope of the frequency-down phase of the first triangular wave is different from the slope of the frequency-down phase of the second triangular wave. For example, in some embodiments, referring to FIGS. 4A-4D, the absolute value of the slope of the frequency-up phase of the first triangular wave is equal to the absolute value of the slope of the frequency-down phase of the second triangular wave. The absolute value of the slope of the frequency-up phase of the first triangular wave is equal to the absolute value of the slope of the frequency-down phase of the second triangular wave. In other embodiments, the absolute value of the slope of the frequency-up phase of the first triangular wave is not equal to the absolute value of the slope of the frequency-down phase of the second triangular wave. The absolute value of the slope of the frequency-up phase of the first triangular wave is not equal to the absolute value of the slope of the frequency-down phase of the second triangular wave. In still other embodiments, the absolute value of the slope of the frequency-up phase of the first triangular wave is equal to the absolute value of the slope of the frequency-down phase of the second triangular wave. The absolute value of the slope of the frequency-up phase of the first triangular wave is not equal to the absolute value of the slope of the frequency-down phase of the second triangular wave. In other embodiments, the absolute value of the slope of the frequency-up phase of the first triangular wave is not equal to the absolute value of the slope of the frequency-down phase of the second triangular wave. The absolute value of the slope of the frequency-up phase of the first triangular wave is equal to the absolute value of the slope of the frequency-down phase of the second triangular wave. In one frequency-sweeping period, the two triangular waves have different shapes but similar working principles. Therefore, the present application only takes the case where the slope of the frequency-up phase of the first triangular wave is smaller than the slope of the frequency-up phase of the second triangular wave as shown in FIG. 4D for illustration.

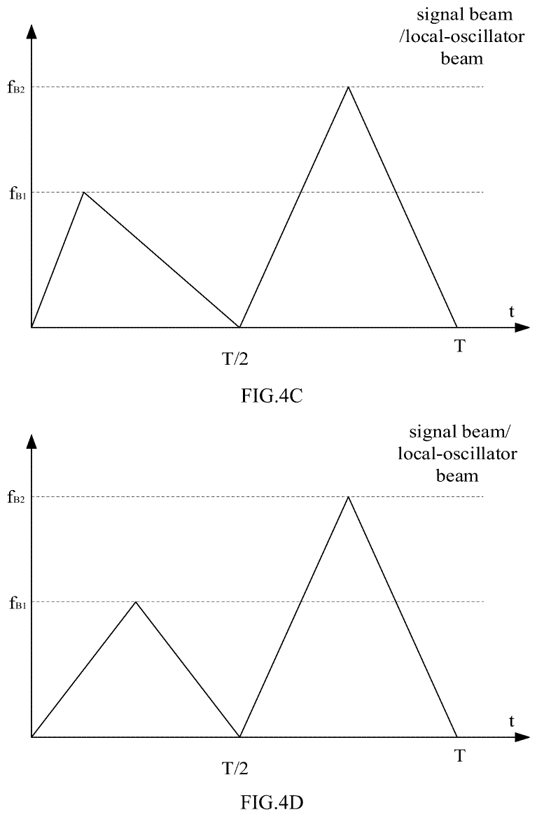

As shown in FIG. 5, when the target object moves towards the LIDAR, due to the Doppler effect, the frequency of the reflected beam is higher than that of the local-oscillator beam. At this time, the beat frequencies f_{bu1} and f_{bu2} in the frequency-up phase become smaller. The reduced value may be smaller than the minimum detectable value of the actual circuit design or calculation method, and even f_{bu1} and f_{bu2} may be negative. At this time, f_{bd1} and f_{bd2} may still be large positive values. f_{bd1} and f_{bd2} can be used to calculate the distance and speed of the target object. In FIG. 5, the solid triangular wave represents the instantaneous time-frequency relationship of the signal beam or local-oscillator beam of the radar, and the dashed triangular wave represents the instantaneous time-frequency relationship of the reflected beam of the target object. Among them, τ is the delay of the reflected beam of the stationary target object, which is caused by the round-trip flight of the laser beam between the target object and the LIDAR. T is the period of the frequency-up sweep and frequency-down sweep, f_{bu1} and f_{bd1} are the beat frequencies of the reflected beam of the first triangular wave in the frequency-up sweep part and the frequency-down sweep part respectively, and f_{B1} is the frequency-sweeping bandwidth of the linear frequency modulation of the first triangular wave. f_{bu2} and f_{bd2} are the beat frequencies of the reflected beam of the second triangular wave in the frequency-up sweep part and the frequency-down sweep part respectively, and f_{B2} is the frequency-sweeping bandwidth of the linear frequency modulation of the second triangular wave.

Using the triangular wave signal of the present application, the beat frequency of the frequency-down phase of the first triangular wave waveform is:

$${f}_{bd 1} = \frac{2 {f}_{B 1}}{T} \cdot \frac{2 D}{c} + \frac{2 v}{λ} \qquad Formula 7$$

The beat frequency of the frequency-down phase of the second triangular wave waveform is:

$${f}_{bd 2} = \frac{2 {f}_{B 2}}{T} \cdot \frac{2 D}{c} + \frac{2 v}{λ} \qquad Formula 8$$

Then, the distance D and speed v of the target object are as follows:

$$\{ \begin{matrix}D = \frac{( {f}_{bd 2} - {f}_{bd 1} ) \times T \times c}{( {f}_{B 2} - {f}_{B 1} ) \times 4} \\ v = \frac{( \frac{{f}_{B 2}}{{f}_{B 1}} \times {f}_{bd 1} - {f}_{bd 2} ) \times λ}{( \frac{{f}_{B 2}}{{f}_{B 1}} - 1 ) \times 2}\end{matrix} \qquad Formula 9$$

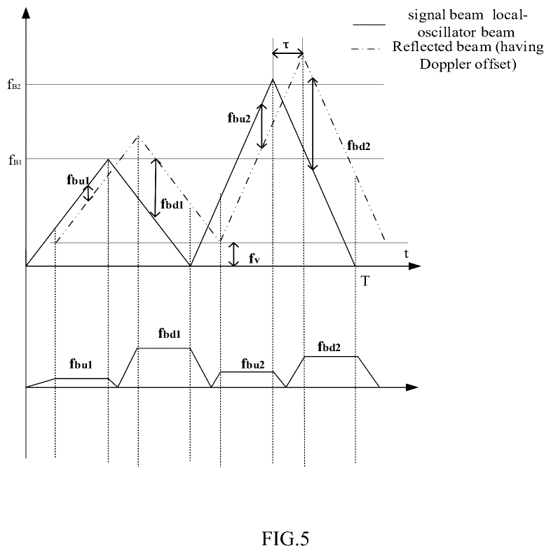

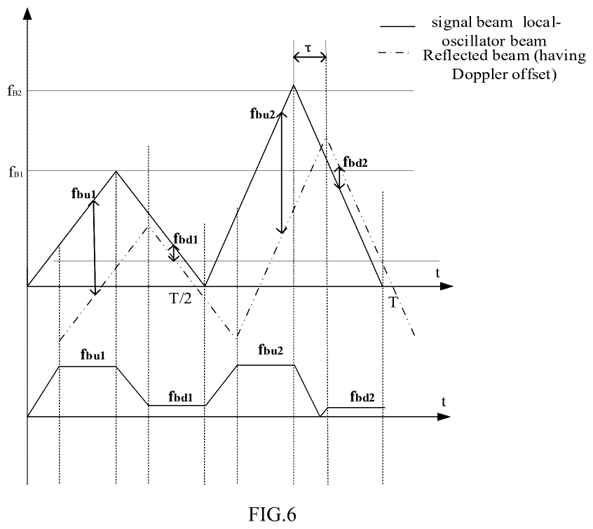

As shown in FIG. 6, when the target object moves away from the LIDAR, due to the Doppler effect, the frequency of the reflected beam is lower than that of the local-oscillator beam. At this time, the beat frequencies f_{bd1} and f_{bd2} in the frequency-down phase may become smaller. The reduced value may be smaller than the minimum detectable value of the actual circuit design or calculation method, and even f_{bd1} and f_{bd2} may be negative. At this time, f_{bu1} and f_{bu2} may still be large positive values. f_{bu1} and f_{bu2} can be used to calculate the distance and speed of the target object. Using the triangular wave signal of the present application, the beat frequency of the frequency-up phase of the first triangular wave waveform is:

$${f}_{bu 1} = \frac{2 {f}_{B 1}}{T} \cdot \frac{2 D}{c} + \frac{2 v}{λ} \qquad Formula 10$$

The beat frequency of the frequency-up phase of the second triangular wave waveform is:

$${f}_{bu 2} = \frac{2 {f}_{B 2}}{T} \cdot \frac{2 D}{c} + \frac{2 v}{λ} \qquad Formula 11$$

Then, the distance D and speed v of the target object are as follows:

$$\{ \begin{matrix}D = \frac{( {f}_{bu 2} - {f}_{bu 1} ) \times T \times c}{( {f}_{B 2} - {f}_{B 1} ) \times 4} \\ v = \frac{( \frac{{f}_{B 2}}{{f}_{B 1}} \times {f}_{bu 1} - {f}_{bu 2} ) \times λ}{( \frac{{f}_{B 2}}{{f}_{B 1}} - 1 ) \times 2}\end{matrix} \qquad Formula 12$$

By adopting the two triangular wave waveforms with different frequency-sweeping bandwidths and different slopes provided in the present application, it can be ensured that at least two beat frequencies can be used to calculate the distance and speed of the target object in any case, thereby avoiding the measurement blind area of the LIDAR.

In some embodiments, when the above Formulas 3 to 6 are used to calculate the beat frequencies in the frequency-up phase and the frequency-down phase, fᵥ is positive when the target object moves towards the LIDAR, and fᵥ is negative when the target object moves away from the LIDAR;

according to the above Formulas 3 and 4,

$${f}_{bu} = \frac{2 {f}_{B}}{T} \cdot \frac{2 D}{c} - \frac{2 v}{λ}$$

$${f}_{bd} = \frac{2 {f}_{B}}{T} \cdot \frac{2 D}{c} + \frac{2 v}{λ}$$

When the target object moves towards the LIDAR, f_{bd}>f_{bu}; When the target object moves away from the LIDAR, f_{bu}>f_{bd}. The moving direction of the target object can be determined according to the magnitudes of f_{bu} and f_{bd}. Based on the FMCW LIDAR including two triangular wave waveforms with different shapes in the same frequency-sweeping period of the present application, the present application provides a method for determining the speed and distance of a target object using the beat frequency values in two of the first frequency-up phase, first frequency-down phase, second frequency-up phase, and second frequency-down phase;

The method includes the following steps 1-3:
Step 1: Determine whether (f_{bu1}+f_{bu2}) is greater than (f_{bd}1+f_{bd2}). If (f_{bu1}+f_{bu2}) is greater than (f_{bd}1+f_{bd2}), then it can be determined that the target object is moving away from the LIDAR. If (f_{bu1}+f_{bu2}) is less than (f_{bd}1+f_{bd2}), then it can be determined that the target object is moving towards the LIDAR.
Step 2: When the target object is moving away from the LIDAR, determine whether f_{bd1} and f_{bd2} are positive values, where:
2.1 If both f_{bd1} and f_{bd2} are positive values, then the speed v and distance D of the target object can be calculated using the above Formulas 5 and 6 and using the beat frequency f_{bu1} of the first frequency-up phase and the beat frequency f_{bd1} of the first frequency-down phase or using the beat frequency f_{bu2} of the second frequency-up phase and the beat frequency f_{bd2} of the second frequency-down phase;
2.2 If f_{bd1} is a positive value and f_{bd2} is a negative value, then it can be determined that the beat frequency f_{bd2} of the second frequency-down phase enters the measurement blind area of the LIDAR;
The speed v and distance D of the target object can be calculated using the beat frequency f_{bu1} of the first frequency-up phase, the beat frequency f_{bd1} of the first frequency-down phase, and the above Formulas 5 and 6;
2.3 If f_{bd2} is a positive value and f_{bd1} is a negative value, then it can be determined that the beat frequency f_{bd1} of the first frequency-down phase enters the measurement blind area of the LIDAR;
The speed and distance of the target object can be calculated using the beat frequency f_{bu2} of the second frequency-up phase, the beat frequency f_{bd2} of the second frequency-down phase, and the above Formulas 5 and 6;
2.4 If both f_{bd1} and f_{bd2} are negative values, then it can be determined that both the beat frequency f_{bd1} of the first frequency-down phase and the beat frequency f_{bd2} of the second frequency-down phase enter the measurement blind area of the LIDAR;
The speed v and distance D of the target object can be calculated using the beat frequency f_{bu1} of the first frequency-up phase, the beat frequency f_{bu2} of the second frequency-up phase, and the above Formulas 10-12.
Step 3: When the target object is moving towards the LIDAR, determine whether f_{bu1} and f_{bu2} are positive values, where:
3.1 If both f_{bu1} and f_{bu2} are positive values, then the speed v and distance D of the target object can be calculated using the above Formulas 3 and 4 and using the beat frequency f_{bu1} of the first frequency-up phase and the beat frequency f_{bd1} of the first frequency-down phase or using the beat frequency f_{bu2} of the second frequency-up phase and the beat frequency f_{bd2} of the second frequency-down phase;
3.2 If f_{bu1} is a positive value and f_{bu2} is a negative value, then it can be determined that the beat frequency f_{bu2} of the second frequency-up phase enters the measurement blind area of the LIDAR;
The speed v and distance D of the target object can be calculated using the beat frequency f_{bu1} of the first frequency-up phase, the beat frequency f_{bd1} of the first frequency-down phase, and the above Formulas 3 and 4;
3.3 If f_{bu2} is a positive value and f_{bu1} is a negative value, then it can be determined that the beat frequency f_{bu1} of the first frequency-up phase enters the measurement blind area of the LIDAR;
The speed v and distance D of the target object can be calculated using the beat frequency f_{bu2} of the second frequency-up phase, the beat frequency f_{bd2} of the second frequency-down phase, and the above Formulas 3 and 4;
3.4 If both f_{bu1} and f_{bu2} are negative values, then it can be determined that both the beat frequency f_{bu1} of the first frequency-up phase and the beat frequency f_{bu2} of the second frequency-up phase enter the measurement blind area of the LIDAR;
The speed v and distance D of the target object can be calculated using the beat frequency f_{bd1} of the first frequency-down phase, the beat frequency f_{bd2} of the second frequency-down phase, and the above Formulas 7-9.

By adopting the two triangular wave waveforms with different frequency-sweeping bandwidths and different slopes provided in the present application, it can be ensured that at least two beat frequencies can be used to calculate the distance and speed of the target object in any case, thereby avoiding the measurement blind area of the LIDAR.

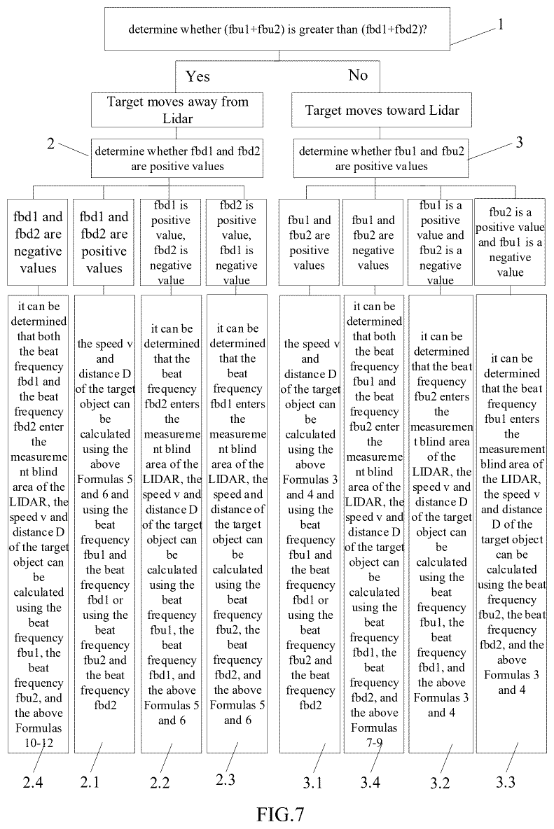

FIG. 8 shows a schematic structural diagram of the LIDAR distance measurement system provided in the present application. The LIDAR distance measurement system can be applied to frequency-modulated continuous-wave (FMCW) LIDAR;

Referring to FIG. 8, the present application provides a distance measurement system for LIDAR. The distance measurement system includes: a laser source 81, a beam splitter 82, an optical transceiver 83, a frequency mixer 84, a balanced detector 85, a detector 86, and a measuring device 87.

The laser source 81 is configured to generate a frequency-swept light beam. The laser source 81 can be directly modulated by the chirp signal of the optical signal. For example, the driving signal controlling the laser source 81 can be input to the laser source 81 with an intensity that changes with time, so that the laser source 81 generates and outputs a frequency-swept light beam, that is, a light beam whose frequency changes within a predetermined range. The laser source 81 may also include a modulator that receives a modulation signal. The modulator may be configured to modulate the light beam based on the modulation signal to generate and output a frequency-swept light beam, where the frequency of the frequency-swept light beam changes within a predetermined range. The laser source 81 may be a common laser source in FMCW LIDAR, and for the sake of brevity, it will not be described in detail in the present application.

The beam splitter 82 is configured to split the frequency-swept light beam into a signal light beam and a local-oscillator light beam. The signal light beam and the local-oscillator light beam have the same frequency at any time point, that is, the frequency modulation waveforms of the signal light beam and the local-oscillator light beam are completely the same. In some examples, the beam splitter 82 may specifically be a specific wavelength coupler (beam splitter) for wavelengths of 445˜2100 nm, such as a beam splitter of the SMC series. In other examples, other beam splitters known to those skilled in the art that can split the frequency-swept light beam into a signal light beam and a local-oscillator light beam may also be used. Each of the signal light beam and the local-oscillator light beam includes a first frequency-up phase, a second frequency-up phase, a first frequency-down phase, and a second frequency-down phase, where the slope of the first frequency-up phase is different from the slope of the second frequency-up phase, and the slope of the first frequency-down phase is different from the slope of the second frequency-down phase, as shown in FIGS. 4A-4D.

The signal light beam is incident on the light incident port of the optical transceiver 83. The optical transceiver 83 is configured to emit the signal light towards the target object. The signal light beam is incident on the target object to generate a reflected light beam, and the optical transceiver 83 is also configured to receive the reflected light beam. The optical transceiver 83 inputs the reflected light beam to the frequency mixer 84. The frequency mixer 84 is also configured to receive the local-oscillator light beam and perform optical frequency mixing between the local-oscillator light beam and the reflected light beam. The mixed signal is, for example, a coherent signal generated by the interference between the local-oscillator light beam and the corresponding reflected light beam. The mixed signals are respectively sent to the balanced detector 85 for detection. The frequency mixer 84 may be a 2×2 optical coupler. The balanced detector 85 may include, for example, a photoelectric detector 851 and a photoelectric detector 852. The photoelectric detector can obtain the beat frequency electrical signal between the local-oscillator light beam and the reflected light beam. The detector 86 is configured to obtain the beat frequency electrical signal from the balanced detector 85, and detect the beat frequency f_{bu1} of the first frequency-up phase, the beat frequency f_{bu2} of the second frequency-up phase, the beat frequency f_{bd1} of the first frequency-down phase, and the beat frequency f_{bd2} of the second frequency-down phase between the local-oscillator light beam and the reflected light beam according to the beat frequency electrical signal. The measuring device 87 is configured to use the beat frequency f_{bu1} of the first frequency-up phase and the beat frequency f_{bu2} of the second frequency-up phase to measure the speed v of the target object and/or the distance D between the target object and the LIDAR, or use the beat frequency f_{bd1} of the first frequency-down phase and the beat frequency f_{bd2} of the second frequency-down phase to measure the speed v of the target object and/or the distance D between the target object and the LIDAR.

In some embodiments, the measuring device 87 is specifically configured to: obtain the distance D between the target object and the LIDAR using the following formula: D=k₀×(f_{bu2}−f_{bu1})/(k_{f}−1), where k₀ is a preset value related to the LIDAR, and k_{f} is a parameter related to the ratio of the slope of the first frequency-up phase to the slope of the second frequency-up phase.

Optionally, the measuring device 87 is specifically configured to: obtain the distance D between the target object and the LIDAR using the following formula: D=k₀×(f_{bu2}−f_{bd1})/(k_{f}−1), where k₀ is a preset value related to the LIDAR, and k_{f} is a parameter related to the ratio of the slope of the first frequency-down phase to the slope of the second frequency-down phase.

Optionally, the measuring device 87 is specifically configured to: obtain the speed V of the target object using the following formula: V=k₁×(k_{f}×f_{bu1}−f_{bu2})/(k_{f}−1), where k₁ is a preset value related to the LIDAR, and k_{f} is a parameter related to the ratio of the slope of the first frequency-up phase to the slope of the second frequency-up phase.

Optionally, the measuring device 87 is specifically configured to: obtain the speed V of the target object using the following formula: V=k₁×(k_{f}×f_{bd1}−f_{bd2})/(k_{f}−1), where k₁ is a preset value related to the LIDAR, and k_{f} is a parameter related to the ratio of the slope of the first frequency-down phase to the slope of the second frequency-down phase.

Optionally, the LIDAR further includes: a polarization beam splitter (for example, a polarization splitter-rotator (PSR)): disposed between the optical transceiver 83 and the target object, configured to change the polarization direction of the light beam or combine multiple light beams into a polarized light beam. A lens assembly configured to collimate the signal light beam and focus the reflected light beam to couple into the optical transceiver, and a beam scanning guiding device configured to realize the deflection and scanning of light.

By adopting the two triangular wave waveforms with different frequency-sweeping bandwidths and different slopes provided in the present application, it can be ensured that at least two beat frequencies can be used to calculate the distance and speed of the target object in any case, thereby avoiding the measurement blind area of the LIDAR.

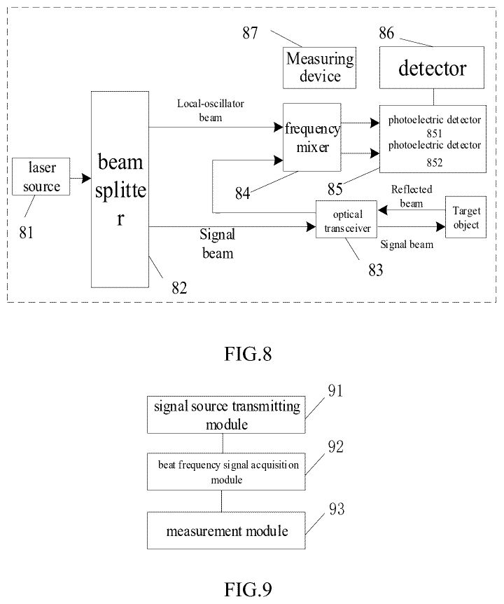

FIG. 9 shows another schematic structural diagram of the LIDAR distance measurement system provided in the present application; Referring to FIG. 9, the LIDAR distance measurement system provided in the present application includes: a signal source transmitting module 91, a beat frequency signal acquisition module 92, and a measurement module 93.

The signal source transmitting module 91 is used to transmit a periodic frequency-modulated continuous wave to a target object. Where the time-frequency waveform of the frequency-modulated continuous wave in one frequency-sweeping period includes a first frequency-up phase, a second frequency-up phase, a first frequency-down phase, and a second frequency-down phase, the slope of the first frequency-up phase is different from the slope of the second frequency-up phase, and the slope of the first frequency-down phase is different from the slope of the second frequency-down phase, as shown in FIGS. 4A-4D.

The beat frequency signal acquisition module 92 is used to respectively obtain the beat frequency f_{bd1} of the first frequency-down phase, the beat frequency f_{bd2} of the second frequency-down phase, the beat frequency f_{bu1} of the first frequency-up phase, and the beat frequency f_{bu2} of the second frequency-up phase based on the reflected signal returned by the target object.

The measurement module 93 is configured to use the beat frequency f_{bu1} of the first frequency-up phase and the beat frequency f_{bu2} of the second frequency-up phase to measure the speed v of the target object and/or the distance D between the target object and the LIDAR, or use the beat frequency f_{bd1} of the first frequency-down phase and the beat frequency f_{bd2} of the second frequency-down phase to measure the speed v of the target object and/or the distance D between the target object and the LIDAR.

In some embodiments, the measurement module 93 is specifically configured to: obtain the distance D between the target object and the LIDAR using the following formula: D=k₀×(f_{bu2}−f_{bu1})/(k_{f}−1), where k₀ is a preset value related to the LIDAR, and k_{f} is a parameter related to the ratio of the slope of the first frequency-up phase to the slope of the second frequency-up phase.

Optionally, the measurement module 93 is specifically configured to: obtain the distance D between the target object and the LIDAR using the following formula: D=k₀×(f_{bd2}−f_{bd1})/(k_{f}−1), where k₀ is a preset value related to the LIDAR, and k_{f} is a parameter related to the ratio of the slope of the first frequency-down phase to the slope of the second frequency-down phase.

Optionally, the measurement module 93 is specifically configured to: obtain the speed V of the target object using the following formula: V=k₁×(k_{f}×f_{bu1}−f_{bu2})/(k_{f}−1), where k₁ is a preset value related to the LIDAR, and k_{f} is a parameter related to the ratio of the slope of the first frequency-up phase to the slope of the second frequency-up phase.

Optionally, the measurement module 93 is specifically configured to: obtain the speed V of the target object using the following formula: V=k₁×(k_{f}×f_{bd1}−f_{bd2})/(k_{f}−1), where k₁ is a preset value related to the LIDAR, and k_{f} is a parameter related to the ratio of the slope of the first frequency-down phase to the slope of the second frequency-down phase.

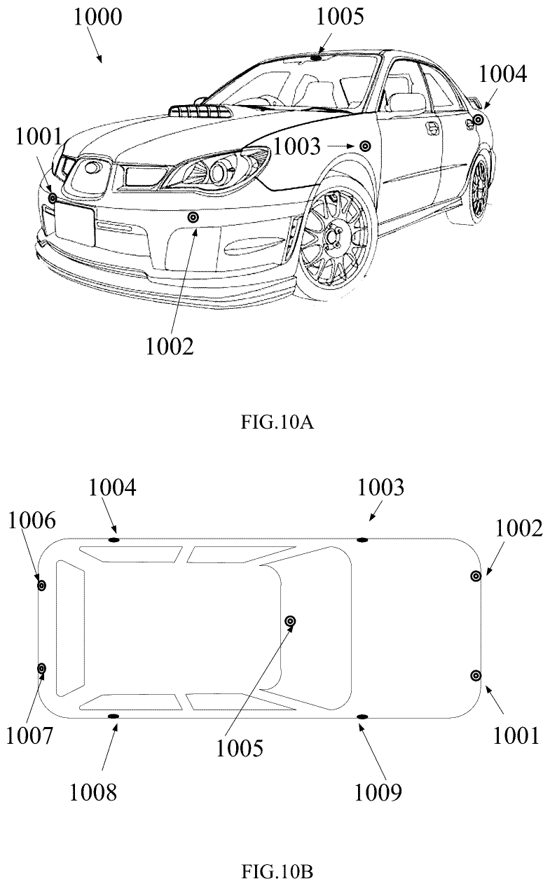

FIGS. 10A and 10B illustrate an example autonomous vehicle 1000 according to an embodiment of the present application, which may include any component of the LIDAR measurement system shown in FIG. 8 or 9 of the present application;

the illustrated autonomous vehicle 1000 includes a sensor array configured to capture one or more target objects in the external environment of the autonomous vehicle and generate sensor data related to the captured one or more target objects for controlling the operation of the autonomous vehicle 1000. FIG. 10A shows sensors 1001, 1002, 1003, 1004, and 1005. FIG. 10B illustrates sensors 1001, 1002, 1003, 1004, 1005, 1006, 1007, 1008, and 1009. FIG. 10B shows a top view of the autonomous vehicle 1000. Any of the sensors 1001, 1002, 1003, 1004, 1005, 1006, 1007, 1008, and 1009 may include the measurement system for LIDAR in FIG. 8 or 9 of the present application. The autonomous vehicle may include a powertrain including a prime mover powered by an energy source and capable of providing power to the transmission system. The autonomous vehicle may also include a control system including direction control, powertrain control, and brake control. The autonomous vehicle can be implemented as any number of different vehicles, including vehicles that can transport people and/or goods and can travel in a variety of different environments. It should be understood that the above components can vary widely based on the type of vehicle in which they are used.

The technical solutions of the present application solve the problem that the reflected beam used to calculate distance and speed includes an optical Doppler frequency shift introduced by the movement of the target object. When the speed of the target object is relatively high, the frequency shift caused by the Doppler effect is greater than the frequency shift caused by the flight time of the reflected beam, which leads to errors in the calculation of short-distance information and thus results in a measurement blind area.

Compared with the related art, the above solutions of the embodiments of the present application have at least the following beneficial effects: by adopting the two triangular wave waveforms with different frequency-sweeping bandwidths and different slopes provided in the present application, it can be ensured that at least two beat frequencies can be used to calculate the distance and speed of the target object in any case, thereby avoiding the measurement blind area of the LIDAR.

It can be understood that the functions of each module in the system of this embodiment correspond to the method steps in the above embodiment. The optional features in the above embodiment are also applicable to this embodiment, so they will not be repeated here.

The above embodiments are only used to illustrate the technical solutions of the present application, rather than limiting them. Although the present application has been described in detail with reference to the foregoing embodiments, those of ordinary skill in the art should understand that: it can still modify the technical solutions recorded in the foregoing embodiments, or replace some of the technical features with equivalents. And these modifications or replacements do not make the essence of the corresponding technical solutions deviate from the spirit and scope of the technical solutions of the embodiments of the present application.

What is claimed is:

1. A distance measurement method for LIDAR, comprising:
generating a frequency-swept light beam;
splitting the frequency-swept light beam into a signal light beam and a local-oscillator light beam, where each of the signal light beam and the local-oscillator light beam includes a first frequency-up phase, a second frequency-up phase, a first frequency-down phase, and a second frequency-down phase, the slope of the first frequency-up phase is different from that of the second frequency-up phase, and the slope of the first frequency-down phase is different from that of the second frequency-down phase;
emitting the signal light beam;
receiving the reflected light beam generated by the reflection of the signal light beam when it encounters a target object;
detecting the beat frequencies of the first frequency-up phase, the second frequency-up phase, the first frequency-down phase, and the second frequency-down phase between the local-oscillator light beam and the reflected light beam; and
using the beat frequencies of the first frequency-up phase and the second frequency-up phase to measure the speed of the target object and/or the distance between the target object and the LIDAR; or using the beat frequencies of the first frequency-down phase and the second frequency-down phase to measure the speed of the target object and/or the distance between the target object and the LIDAR.

2. The distance measurement method according to claim 1, wherein using the beat frequencies of the first frequency-up phase and the second frequency-up phase to measure the distance between the target object and the LIDAR comprises:
obtaining the distance D between the target object and the LIDAR using the following formula:
D=k₀×(f_{bu2}−f_{bu1})/(k_{f}−1), where k₀ is a preset value related to the LIDAR, k_{f} is a parameter related to the ratio of the slope of the first frequency-up phase to the slope of the second frequency-up phase, f_{bu1} is the beat frequency of the first frequency-up phase, and f_{bu2} is the beat frequency of the second frequency-up phase.

3. The distance measurement method according to claim 1, wherein using the beat frequencies of the first frequency-down phase and the second frequency-down phase to measure the distance between the target object and the LIDAR comprises:
obtaining the distance D between the target object and the LIDAR using the following formula:
D=k₀×(f_{bd2}−f_{bd1})/(k_{f}−1), where k₀ is a preset value related to the LIDAR, k_{f} is a parameter related to the ratio of the slope of the first frequency-down phase to the slope of the second frequency-down phase, f_{bd1} is the beat frequency of the first frequency-down phase, and f_{bd2} is the beat frequency of the second frequency-down phase.

4. The distance measurement method according to claim 1, wherein using the beat frequencies of the first frequency-up phase and the second frequency-up phase to measure the speed of the target object comprises:
obtaining the speed V of the target object using the following formula:
V=k₁×(k_{f}×f_{bu1}−f_{bu2})/(k_{f}−1), where k₁ is a preset value related to the LIDAR, k_{f} is a parameter related to the ratio of the slope of the first frequency-up phase to the slope of the second frequency-up phase, f_{bu1} is the beat frequency of the first frequency-up phase, and f_{bu2} is the beat frequency of the second frequency-up phase.

5. The distance measurement method according to claim 1, wherein using the beat frequencies of the first frequency-down phase and the second frequency-down phase to measure the speed of the target object comprises:
obtaining the speed V of the target object using the following formula:
V=k₁×(k_{f}×f_{bd1}−f_{bd2})/(k_{f}−1), where k₁ is a preset value related to the LIDAR, k_{f} is a parameter related to the ratio of the slope of the first frequency-down phase to the slope of the second frequency-down phase, f_{bd1} is the beat frequency of the first frequency-down phase, and f_{bd2} is the beat frequency of the second frequency-down phase.

6. A distance measurement system for LIDAR, comprising:
a laser source configured to generate a frequency-swept light beam;
a beam splitter configured to split the frequency-swept light beam into a signal light beam and a local-oscillator light beam, where each of the signal light beam and the local-oscillator light beam includes a first frequency-up phase, a second frequency-up phase, a first frequency-down phase, and a second frequency-down phase, the slope of the first frequency-up phase is different from that of the second frequency-up phase, and the slope of the first frequency-down phase is different from that of the second frequency-down phase;
an optical transceiver configured to emit the signal light beam and receive the reflected light beam generated by the reflection of the signal light beam when it encounters a target object;
a frequency mixer configured to perform optical frequency mixing between the local-oscillator light beam and the reflected light beam;
a balanced detector configured to obtain the beat frequency electrical signal between the local-oscillator light beam and the reflected light beam;
a detector configured to obtain the beat frequency electrical signal from the balanced detector, and detect the beat frequencies of the first frequency-up phase, the second frequency-up phase, the first frequency-down phase, and the second frequency-down phase between the local-oscillator light beam and the reflected light beam according to the beat frequency electrical signal; and
a measuring device configured to use the beat frequencies of the first frequency-up phase and the second frequency-up phase to measure the speed of the target object and/or the distance between the target object and the LIDAR; or use the beat frequencies of the first frequency-down phase and the second frequency-down phase to measure the speed of the target object and/or the distance between the target object and the LIDAR.

7. The distance measurement system according to claim 6, wherein the measuring device is specifically configured to:
obtain the distance D between the target object and the LIDAR using the following formula:
D=k₀×(f_{bu2}−f_{bu1})/(k_{f}−1), where k₀ is a preset value related to the LIDAR, k_{f} is a parameter related to the ratio of the slope of the first frequency-up phase to the slope of the second frequency-up phase, f_{bu1} is the beat frequency of the first frequency-up phase, and f_{bu2} is the beat frequency of the second frequency-up phase.

8. The distance measurement system according to claim 6, wherein the measuring device is specifically configured to:
obtain the distance D between the target object and the LIDAR using the following formula:
D=k₀×(f_{bd2}−f_{bd1})/(k_{f}−1), where k₀ is a preset value related to the LIDAR, k_{f} is a parameter related to the ratio of the slope of the first frequency-down phase to the slope of the second frequency-down phase, f_{bd1} is the beat frequency of the first frequency-down phase, and f_{bd2} is the beat frequency of the second frequency-down phase.

9. The distance measurement system according to claim 6, wherein the measuring device is specifically configured to:
obtain the speed V of the target object using the following formula:
V=k₁×(k_{f}×f_{bu1}−f_{bu2})/(k_{f}−1), where k₁ is a preset value related to the LIDAR, k_{f} is a parameter related to the ratio of the slope of the first frequency-up phase to the slope of the second frequency-up phase, f_{bu1} is the beat frequency of the first frequency-up phase, and f_{bu2} is the beat frequency of the second frequency-up phase.

10. The distance measurement system according to claim 6, wherein the measuring device is specifically configured to:
obtain the speed V of the target object using the following formula:
V=k₁×(k_{f}×f_{bd1}−f_{bd2})/(k_{f}−1), where k₁ is a preset value related to the LIDAR, k_{f} is a parameter related to the ratio of the slope of the first frequency-down phase to the slope of the second frequency-down phase, f_{bd1} is the beat frequency of the first frequency-down phase, and f_{bd2} is the beat frequency of the second frequency-down phase.
